(19) United States
(12) Patent Application Publication
(10) Pub. No.: US 2010/0149154 A1
(43) Pub. Date: Jun. 17, 2010

(54) Energy recovery circuit

(75) Inventors: Kyoung-Pil Jin, Suwon-si (KR); Yoo-Jin Song, Suwon-si (KR)

Correspondence Address: ROBERT E. BUSHNELL & LAW FIRM, 2029 K STREET NW, SUITE 600, WASHINGTON, DC, 20006-1004, US

(73) Assignee: Samsung SDI Co., Ltd., Suwon-si (KR)

(21) Appl. No.: 12/591,992

(22) Filed: Dec. 7, 2009

(30) Foreign Application Priority Data
Dec. 11, 2008 (KR) 10-2008-0125751

(51) Int. Cl. G09G 5/00; G09G 3/28

(52) U.S. Cl. 345/211; 345/60

(57) ABSTRACT

An energy recovery circuit for a plasma display panel having a reduced number of components. The energy recovery circuit includes a source capacitor, an inductor, a panel capacitor and six switches. The circuit is designed so that the source capacitor, the inductor and two of the switches are shared in operation, thereby reducing the number of components.

### CROSS-REFERENCE TO RELATED APPLICATIONS

This application makes reference to, incorporates the same herein, and claims all benefits accruing under 35 U.S.C. §119 from an application for ENERGY RECOVERY CIRCUIT earlier filed in the Korean Intellectual Property Office on 11 Dec. 2008 and there duly assigned Serial No. 10-2008-0125751.

### BACKGROUND OF THE INVENTION

1. Field of the Invention

The present invention relates to an energy recovery circuit that can be used in a plasma display panel and is designed to minimize the number of components used.

2. Discussion of Related Art

A plasma display panel (hereinafter, referred to as a ‘PDP’) displays an image including characters or graphics by light-emitting phosphors energized by ultraviolet radiation having a 147 nm wavelength produced during the discharge of an inert mixed gas. PDPs can easily be made thin and large, and can provide greatly increased image quality due to the recent developments of relevant technology.

PDP includes scan electrodes and sustain electrodes which are arranged on an upper substrate, and address electrodes arranged on a lower substrate. The respective scan electrodes and sustain electrodes include transparent electrodes and metal bus electrodes that have a line width smaller than that of the transparent electrodes and are arranged along one edge of the transparent electrodes.

The transparent electrodes, which are typically made of indium tin oxide (ITO), are arranged on the upper substrate. The metal bus electrodes, which are typically made of an opaque metal such as chrome (Cr), are arranged on the transparent electrodes and serve to reduce a voltage drop caused by the transparent electrodes having a higher resistance. On the upper substrate in which the scan electrodes and the sustain electrodes are arranged in parallel with each other are stacked an upper dielectric layer and a protective layer.

The upper dielectric layer accumulates wall charges generated during plasma discharge. The protective layer serves to protect the upper dielectric layer from being sputtered during a plasma discharge, and improve the efficiency of secondary electron emission. Magnesium oxide (MgO) is typically used as the protective layer.

A lower dielectric layer and barrier ribs are arranged on the lower substrate in which the address electrodes are arranged, and a phosphor layer is coated on the surfaces of the lower dielectric layer and the barrier ribs. The address electrodes extend in a direction that intersects the scan electrodes and the sustain electrodes. The barrier ribs are arranged in a stripe and/or mesh pattern to prevent ultraviolet and a visible rays generated during the discharge from leaking into neighboring discharge cells. The phosphor layer is by ultraviolet rays generated during the plasma discharging and generates red, green and blue visible light. An inert mixed gas is injected into the discharge spaces of the discharge cells defined by the upper/lower substrates and the barrier ribs.

In order to sustain the discharge of the PDP as described above, a sustain pulse having a high voltage of several hundreds of volts is applied at a frequency of several hundreds of kHz. The sustain pulse is applied alternately to the scan electrodes and the sustain electrodes, and a brightness is displayed while charging and discharging occurs in the discharge cells due to the sustain pulse.

However, lots of energy loss occurs in the PDP while the sustain pulse is applied. In order to minimize the loss of energy, an energy recovery circuit can be used. The energy recovery circuit recovers energy charged in the discharge cell and later applies the recovered energy back to the discharge cell when a next sustain pulse is applied, thereby minimizing the loss of energy. However, conventional energy recovery circuits include each of the scan electrodes and the sustain electrodes, so that many components are needed, thereby increasing the manufacturing costs. What is therefore needed is an energy recovery circuit for a PDP where the number of components is reduced to reduce manufacturing costs.

### SUMMARY OF THE INVENTION

Therefore, it is an object of the present invention to provide an energy recovery circuit capable of minimizing the number of components.

According to one aspect of the present invention, there is provided an energy recovery circuit that includes a panel capacitor equivalently arranged within a discharge cell, the panel capacitor including a scan electrode and a sustain electrode, a source capacitor, a first switch, a second switch, a third switch, a fourth switch, a fifth switch and a sixth switch, an inductor, the inductor and the sixth switch being connected between the source capacitor and the panel capacitor, the first switch being connected between the sixth switch and the scan electrode of the panel capacitor, the second switch being connected between the sixth switch and the sustain electrode of the panel capacitor, the third switch being connected between the scan electrode of the panel capacitor and ground, the fourth switch being connected between the sustain electrode of the panel capacitor and ground and the fifth switch being connected between a first node and a sustain voltage source, the first node being a common node of the first switch, the second switch and the sixth switch.

The first switch serves to maintain a turn-on state when each of a voltage charged in the source capacitor and the sustain voltage source are applied to the scan electrode. The second switch serves to maintain a turn-on state when each of a voltage charged in the source capacitor and the sustain voltage source are applied to the sustain electrode. The third switch serves to maintain a turn-on state a while voltage is applied to the sustain electrode of the panel capacitor. The fourth switch serves to maintain a turn on state while voltage is applied to the scan electrode of the panel capacitor. The sixth switch serves to maintain a turn on state while each of a voltage being applied from the source capacitor to the panel capacitor and a voltage being recovered from the panel capacitor to the source capacitor. The fifth switch serves to maintain a turn on state for a period of time after when the voltage is applied from the source capacitor to the panel capacitor.

Each of the first switch, the second switch, the third switch, the fourth switch, the fifth switch and the sixth switch can include an internal diode, the internal diode of the first switch can be arranged to allow current to flow from the scan electrode of the panel capacitor to the first node, the internal diode of the second switch being can be arranged to allow current to flow from the sustain electrode of the panel capacitor to the first node, the internal diode of the third switch can be arranged to allow current to flow from ground to the scan electrode, the internal diode of the fourth switch can be arranged to allow current to flow from ground to the sustain electrode, the internal diode of the fifth switch can be arranged to allow current to flow from the first node to the sustain voltage source and the internal diode of the sixth switch can be arranged to allow current to flow from the inductor to the first node.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicated the same or similar components, wherein:

FIG. 1 is a perspective view of a discharge cell of a plasma display panel;

FIG. 2 is a block diagram of the circuits within a plasma display panel according to an embodiment of the present invention;

FIG. 3 is a view of waveforms applied to electrodes within a plasma display panel during a sub field according to an embodiment of the present invention;

FIG. 4 is a view of an energy recovery circuit according to an embodiment of the present invention;

FIG. 5 is a view of waveforms showing switch settings and capacitance charge voltage of the energy recovery circuit of FIG. 4 during a voltage cycle in a sustain period; and

FIGS. 6A to 6F show operation processes of the energy recovery circuit of FIG. 4 that corresponds to six periods illustrated in FIG. 5.

### DETAILED DESCRIPTION OF THE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the principles for the present invention.

Recognizing that sizes and thicknesses of constituent members shown in the accompanying drawings are arbitrarily given for better understanding and ease of description, the present invention is not limited to the illustrated sizes and thicknesses.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. Alternatively, when an element is referred to as being “directly on” another element, there are no intervening elements present.

In order to clarify the present invention, elements extrinsic to the description are omitted from the details of this description, and like reference numerals refer to like elements throughout the specification.

In several exemplary embodiments, constituent elements having the same configuration are representatively described in a first exemplary embodiment by using the same reference numeral and only constituent elements other than the constituent elements described in the first exemplary embodiment will be described in other embodiments.

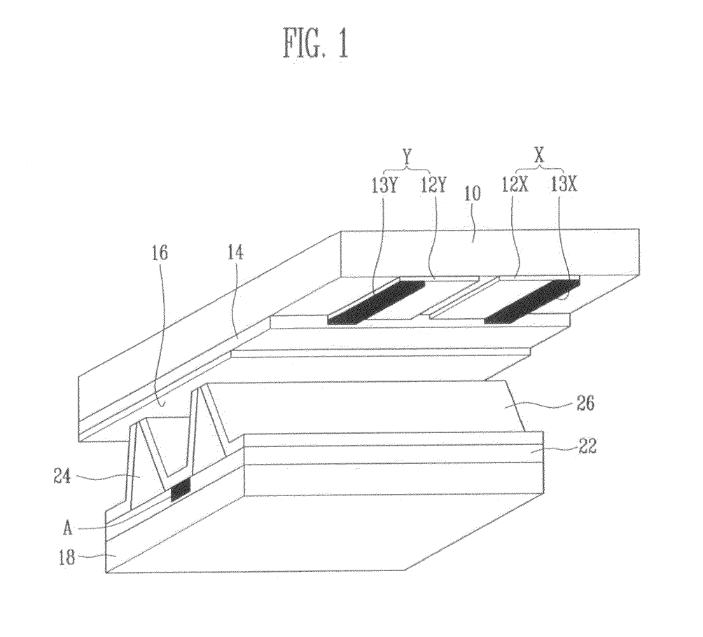

Turning now to FIG. 1, FIG. 1 is a view of a discharge cell of a PDP. Referring to FIG. 1, the discharge cell of the PDP includes a scan electrode Y and a sustain electrode X which are arranged on an upper substrate 10, and an address electrode A arranged on a lower substrate 18. The respective scan electrode Y and sustain electrode X include transparent electrodes 12Y and 12X respectively and metal bus electrodes 13Y and 13X respectively that have a line width smaller than that of the transparent electrodes 12Y and 12X. Each of the metal bus electrodes 13Y and 13X are arranged along an edge of the corresponding transparent electrode 12Y and 12X respectively.

The transparent electrodes 12Y and 12X, which are typically made of indium tin oxide (ITO), are arranged on the upper substrate 10. The metal bus electrodes 13Y and 13X, which are typically made out of an opaque and highly conductive metal such as chrome (Cr), are arranged on the transparent electrodes 12Y and 12X and serve to reduce a voltage drop along the transparent electrodes 12Y and 12X that have a higher resistance. On the upper substrate 10 in which the scan electrodes Y and the sustain electrodes X are arranged in parallel to each other are stacked an upper dielectric layer 14 and a protective layer 16.

The upper dielectric layer 14 accumulates wall charges generated during plasma discharge. The protective layer 16 protects the upper dielectric layer 14 from being sputtered during a plasma discharge, and improves efficiency 8 of secondary electron emission. Magnesium oxide (MgO) is typically used as the protective layer 16.

A lower dielectric layer 22 and barrier ribs 24 are arranged on the lower substrate 18 on which the address electrodes A are arranged, and a phosphor layer 26 is coated on an upper surface of the lower dielectric layer 22 and on sidewalls of the barrier ribs 24. The address electrodes A are arranged in the direction so that they intersect the scan electrodes Y and the sustain electrodes X. The barrier ribs 24 are arranged in a stripe and/or mesh pattern to prevent ultraviolet and visible rays generated by the discharge from leaking into neighboring discharge cells. The phosphor layer 26 is excited by ultraviolet rays generated during the plasma discharge and generates red, green and blue visible light. An inert mixed gas is injected into the discharge spaces of the discharge cells bounded by the upper/lower substrates 10 and 18 and the barrier ribs 24.

In order to sustain the discharge of the PDP as described above, a sustain pulse having a high voltage of several hundreds of volts is applied at a frequency of several hundreds of kHz. The sustain pulse is applied alternately between the scan electrodes Y and the sustain electrodes X, and a brightness is displayed while charging and discharging occurs in the discharge cells due to the sustain pulse.

However, lots of energy loss occurs in the PDP while the sustain pulse is applied. In order to minimize this energy loss, an energy recovery circuit can be used. The energy recovery circuit recovers energy charged in the discharge cell and applies this recovered energy later when the next sustain pulse is applied, thereby minimizing the loss of energy. However, conventional energy recovery circuit include a large number of components, thereby increasing the manufacturing costs.

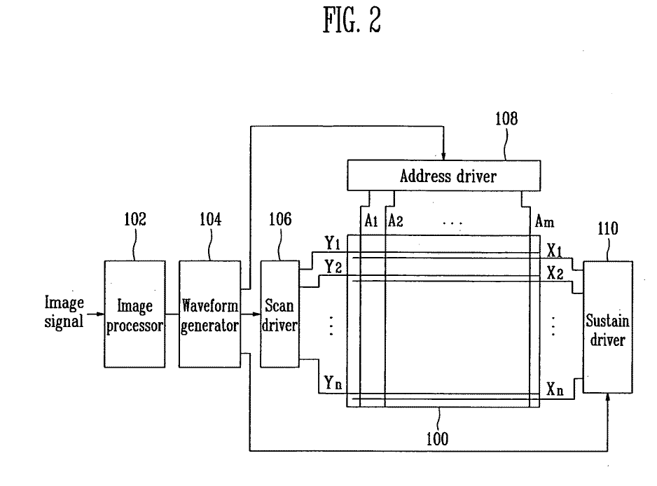

Turning now to FIG. 2, FIG. 2 is a view of a plasma display panel according to an embodiment of the present invention. Referring to FIG. 2, the PDP of the present embodiment includes a panel 100, an address driver 108, a scan driver 106, a sustain driver 110, a waveform generator 104 and an image processor 102.

The image processor 102 receives analog image signals from an external source and converts the received analog image signals into digital image signals. Also, the image processor 102 generates vertical synchronization signals, horizontal synchronization signals, and clock signals, etc. and applies them to the waveform generator 104.

The waveform generator 104 receives the digital image signals, the vertical synchronization signals, the horizontal synchronization signals, and the clock signals from image processor 102, divides the digital image signals for each sub field, and applies the divided image signals to the address driver 108. Also, the waveform generator 104 generates control signals corresponding to the vertical synchronization signals, the horizontal synchronization signals, and the clock signals, and applies the generated control signals to the scan driver 106, the address driver 108 and the sustain driver 110.

The address driver 108 generates data signals corresponding to the image signals and control signals supplied by waveform generator 104 and applies the generated data signals to the address electrodes A1 to Am during an address period of each sub field.

The scan driver 106 generates scan signals corresponding to the control signals supplied from the waveform generator 104 and applies the generated scan signals sequentially to the scan electrodes Y1 to Yn during the address period for each sub field. Also, the scan driver 106 applies a ramp pulse to the scan electrodes Y1 to Yn during a reset period in each sub field, and applies a sustain pulse during a sustain period thereof.

The sustain driver 110 generates sustain pulse signals corresponding to the control signals supplied from the waveform generator 104, and applies these sustain pulse signals to sustain electrodes X1 to Xn during the sustain period in a manner that is alternate with the sustain pulse signals being applied to the scan electrodes Y1 to Yn.

Meanwhile, an energy recovery circuit is included within the scan driver 106 and/or the sustain driver 110 that applies the sustain pulse alternately between the scan electrodes Y1 to Yn and the sustain electrodes X1 to Xn. The detailed constitution of the energy recovery circuit will be described later.

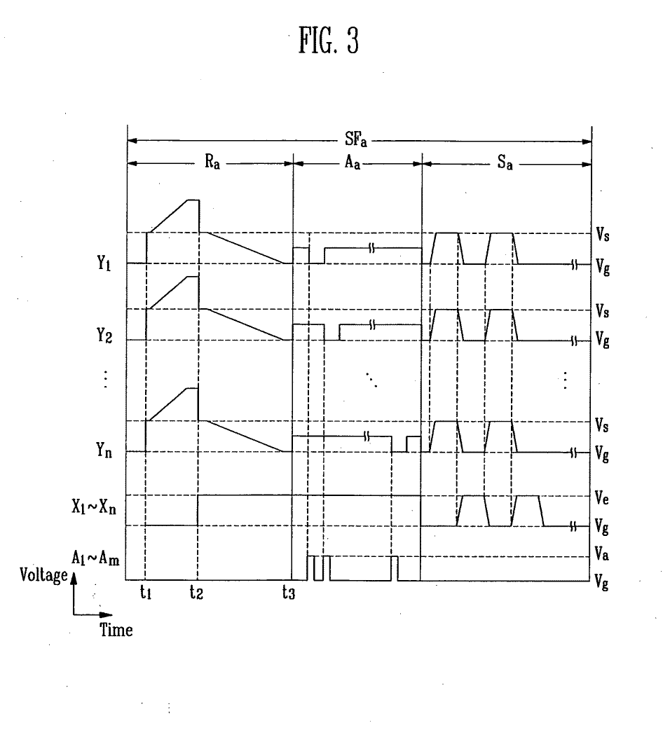

Turning now to FIG. 3, FIG. 3 is a view of waveforms applied to various electrodes within the PDP according to an embodiment of the present invention. FIG. 3 is used to show a driving method of a plasma display panel. For convenience of explanation, FIG. 3 will show a driving waveform applied during just one sub field of a plurality of sub fields included in a frame.

Referring now to FIG. 3, the sub field of the embodiment of the present invention is divided into a reset period Ra, an address period Aa, and a sustain period Sa. In the wall charge accumulation period t1 to t2 of reset period Ra, a rising ramp pulse having a slope is applied to the scan electrodes Y1 to Yn and ground potential is applied to the sustain electrodes X1 to Xn while the address electrodes A1 to Am accumulate wall charges. Then, wall charges of negative polarity accumulate near the scan electrodes Y1 to Yn and wall charges of positive polarity are accumulate near the sustain electrodes X1 to Xn by means of micro discharge by the ramp pulse.

During a wall charge distribution period t2 to t3, a falling ramp pulse having a slope is applied to the scan electrodes Y1 to Yn, and a predetermined voltage Ve is applied to the sustain electrodes X1 to Xn. In addition, a ground potential Vg is applied to the address electrodes A1 to Am during the wall charge distribution period t2 to t3. As a result, the wall charges accumulated near the scan electrodes Y1 to Yn and the sustain electrodes X1 to Xn during the wall charge accumulation period t1 to t2 are reduced. That is, the amount of wall charges accumulated in the discharge cells is reduced during the wall charge distribution period t2 to t3, thereby preventing the occurrence of an excessively strong discharge during the address period Aa.

In the address period Aa, the scan signals are applied sequentially to the scan electrodes Y1 to Yn, and the data signals synchronized with the scan signals are applied to the address electrodes A1 to Am. The voltage difference between the scan signals and the data signals added to the wall voltage generated in the reset period Ra produce an address discharge in the discharge cells in which the data signals are applied. Wall charges required for the sustain discharge are then generated in the discharge cells in which the address discharge has been generated.

In the sustain period Sa, a sustain pulse is applied alternately between the scan electrodes Y1 to Yn and the sustain electrodes X1 to Xn. Then, the wall charges of the discharge cells selected by the address discharge are added to the voltage of the sustain pulse so that a sustain discharge can occur between the scan electrode Y and the sustain electrode X in discharge cells previously selected during the address period Aa.

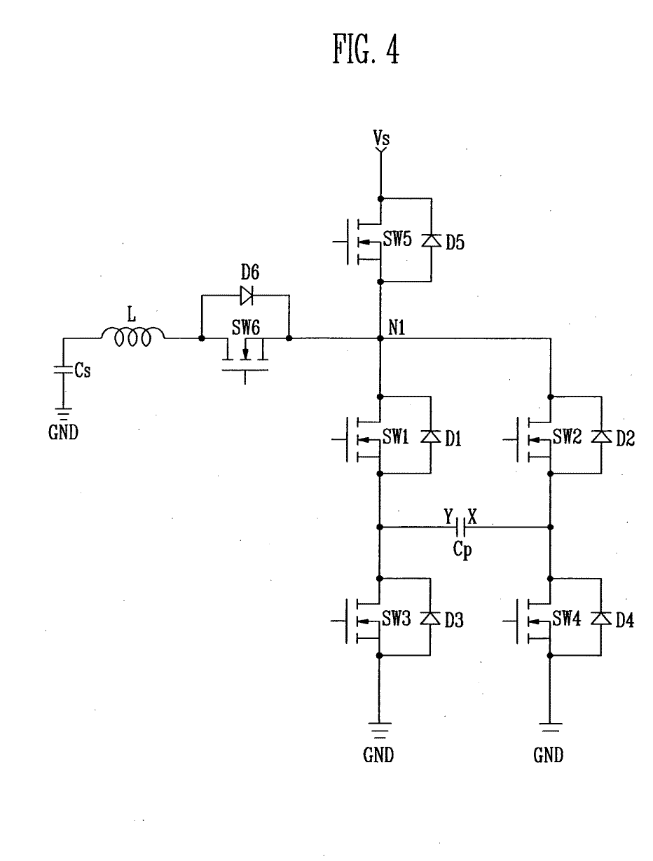

Turning now to FIG. 4, FIG. 4 shows an energy recovery circuit according to an embodiment of the present invention. Referring to FIG. 4, the energy recovery circuit according to an embodiment of the present invention includes a source capacitor Cs, an inductor L and a sixth switch SW6 both connected between the source capacitor Cs and a panel capacitor Cp, a first switch SW1 connected between the scan electrode Y of the panel capacitor Cp and the sixth switch, a second switch SW2 connected between the sixth switch SW6 and the sustain electrode X of the panel capacitor Cp, a third switch SW3 connected between ground GND and the scan electrode Y of the panel capacitor Cp, a fourth switch SW4 connected between sustain electrode X of the panel capacitor Cp and ground GND, and a fifth switch SW5 connected between a first node N1 and a sustain voltage source Vs, the first node N1 being a common node of the first switch SW1, the second switch SW2 and the sixth switch SW6. The panel capacitor Cp equivalently represents capacitance within a discharge cell.

The source capacitor Cs is charged by recovering voltage from the panel capacitor Cp, and the source capacitor Cs later supplies the charged voltage back to the panel capacitor Cp. The capacitance of the source capacitor Cs as described above is selected so that it can be charged to a voltage corresponding to half of the sustain voltage Vs.

The sixth switch SW6 is turned on when either voltage is recovered by the source capacitor Cs or when the recovered voltage is supplied to the panel capacitor Cp. The sixth switch SW6 as described above includes an internal diode D6 to allow current to flow from the inductor L to the first node N1.

The fifth switch SW5 is turned on when the sustain voltage Vs from the sustain voltage source Vs is applied to the panel capacitor Cp. The fifth switch SW5 as described above includes an internal diode D5 to allow current to flow from the first node N1 to the sustain voltage source Vs. The internal diode D5 prevents the voltage of the first node N1 from exceeding the sustain voltage Vs, thereby securing stability of the operation.

The first switch SW1 is positioned between the scan electrode Y of the panel capacitor Cp and the first node N1. The first switch SW1 is turned on (i.e., closed) when either the voltage charged in the source capacitor Cs or the sustain voltage source Vs is applied to the scan electrode Y of the panel capacitor Cp. The first switch SW1 as described above includes an internal diode D1 to allow current to flow from the scan electrode Y of the panel capacitor Cp to the first node N1.

The second switch SW2 is positioned between the sustain electrode X of the panel capacitor Cp and the first node N1. The second switch SW2 is turned on (i.e., closed) when either the voltage charged in the source capacitor Cs or the sustain voltage source Vs is applied to the sustain electrode X of the panel capacitor Cp. The second switch SW2 as described above includes an internal diode D2 to allow current to flow from the sustain electrode X of the panel capacitor Cp to the first node N1.

The third switch SW3 is positioned between the scan electrode Y of the panel capacitor Cp and ground GND. The third switch SW3 is turned on (i.e., closed) when the sustain pulse is applied to the sustain electrode X. The third switch SW3 as described above includes an internal diode D3 to allow current to flow from ground GND to the scan electrode Y. The internal diode D3 prevents the voltage of the scan electrode Y from falling below the ground voltage.

The fourth switch SW4 is positioned between the sustain electrode X of the panel capacitor Cp and ground GND. The fourth switch SW4 is turned on (i.e., closed) when the sustain pulse is applied to the scan electrode Y. The fourth switch SW4 as described above includes an internal diode D4 to allow current to flow from ground GND to the sustain electrode X. The internal diode D4 prevents the voltage of the sustain electrode X from falling below the ground voltage.

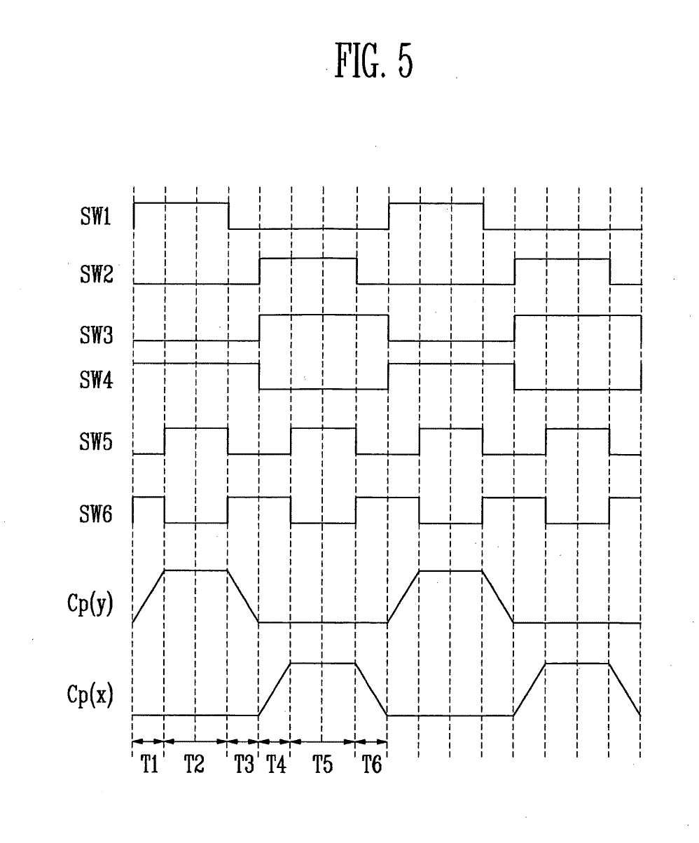

Turning now to FIG. 5, FIG. 5 is a view of waveforms showing the switch settings and the voltages stored in the capacitors of the energy recovery circuit of FIG. 4 during a voltage cycle in a sustain period Sa. When describing the operation process using FIG. 5, it will be assumed that the source capacitor Cs is charged to a voltage of Vs/2.

Referring to FIG. 5, first, during period T1, the first switch SW1, the fourth switch SW4 and the sixth switch SW6 are turned on (i.e., closed). When the first switch SW1 is turned on, the first node N1 is electrically connected to the scan electrode Y of the panel capacitor Cp. When the fourth switch SW4 is turned on, the sustain electrode X of the panel capacitor Cp is grounded. When the sixth switch SW6 is turned on, the inductor L is electrically connected to the first node N1.

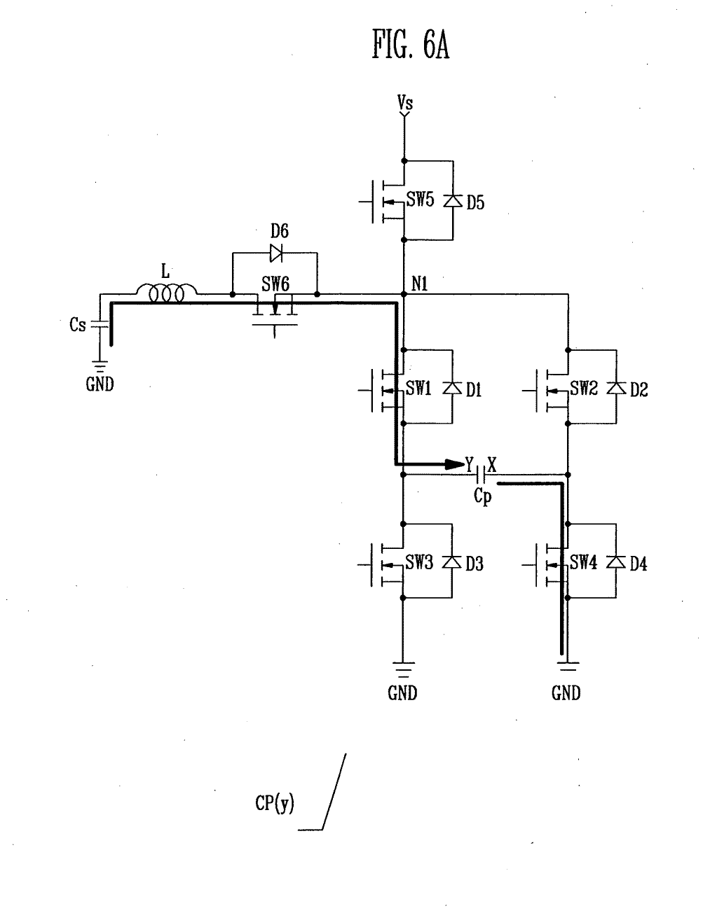

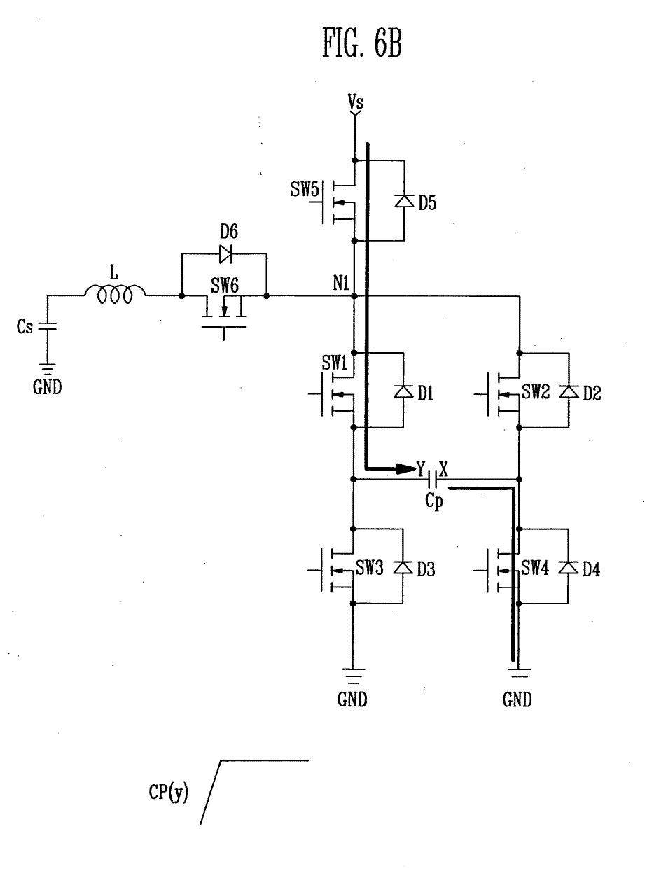

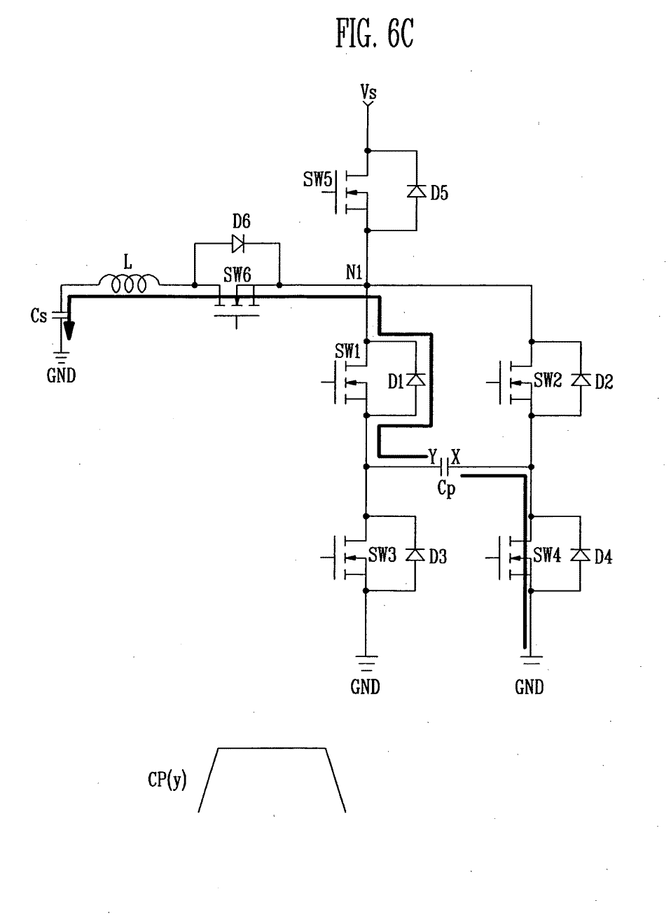

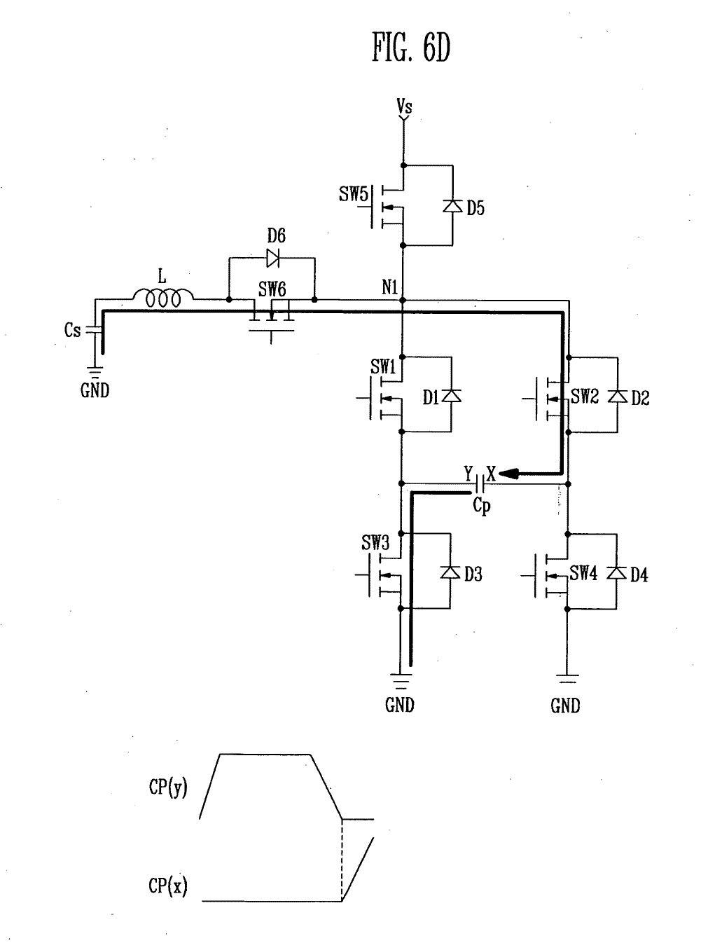

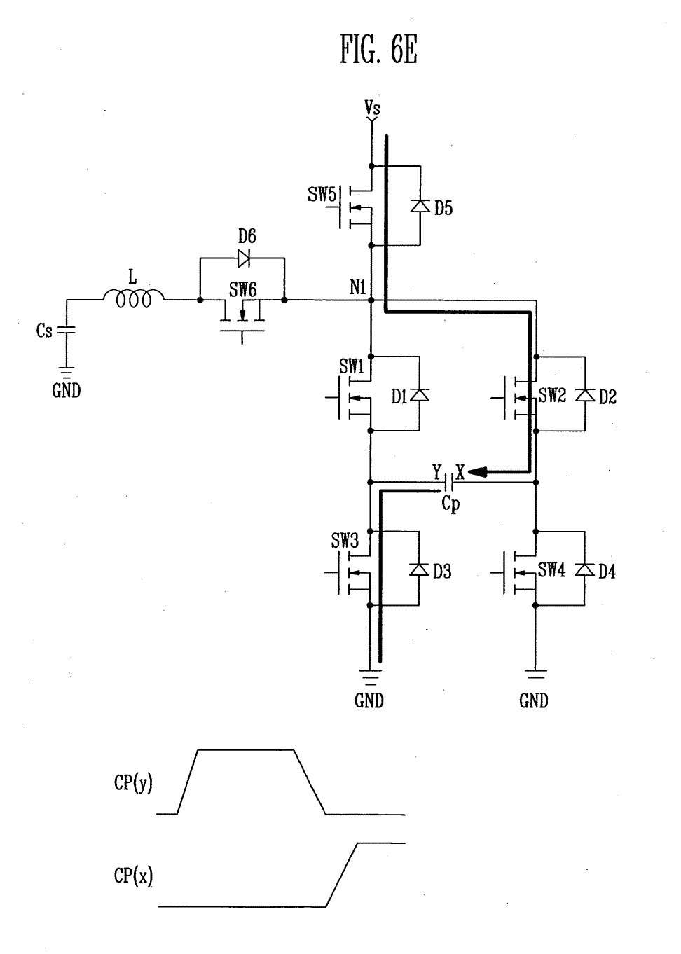

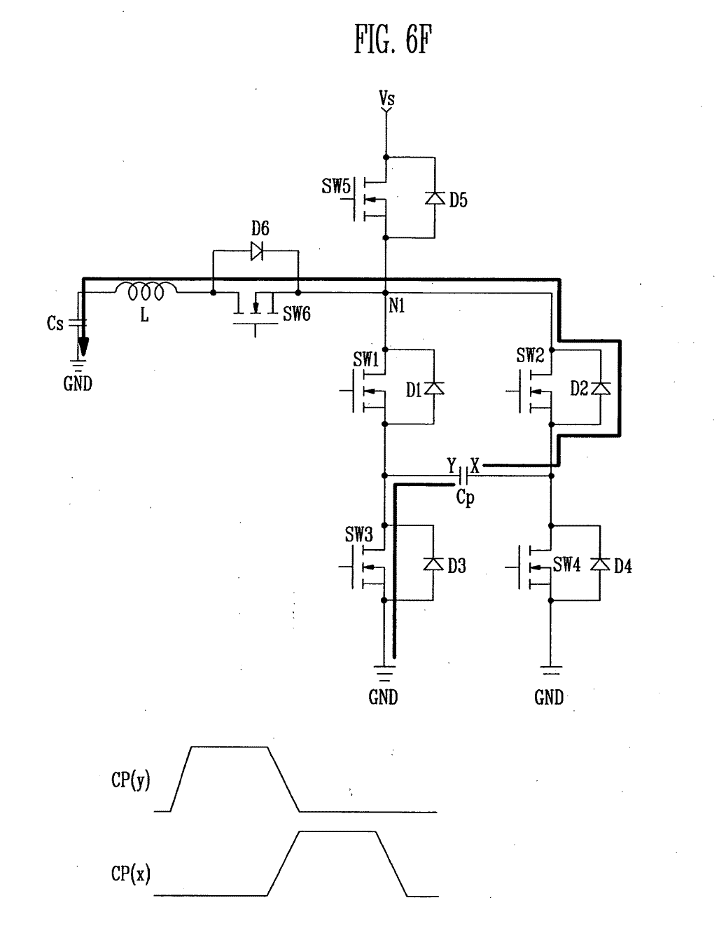

During period T1, as shown in FIG. 6A, the voltage charged in the source capacitor Cs is applied to the scan electrode Y of the panel capacitor Cp via the inductor L, the sixth switch SW6 and the first switch SW1. During period T1, the inductor L and the panel capacitor Cp form a LC resonant circuit. Therefore, the voltage of Vs/2 stored in the source capacitor Cs rises approximately to the voltage of Vs by means of the LC resonant circuit and is applied to the scan electrode Y of the panel capacitor Cp.

During period T2, the fifth switch SW5 is turned on (i.e., closed) and the sixth switch SW6 is turned off (i.e., opened). When the fifth switch SW5 is turned on, the first node N1 is electrically connected to the sustain voltage source Vs. Therefore, as shown in FIG. 6B, the sustain voltage Vs is applied to the scan electrode Y of the panel capacitor Cp via the fifth switch SW5 and the first switch SW1 while the sustain electrode X of panel capacitor Cp is grounded during period T2. Since the panel capacitor Cp is charged to approximately voltage Vs during period T1, energy supplied to the sustain voltage source Vs during period T2 is minimal. The fifth switch SW5 maintains a turn-on state during period T2 so that a stable sustain discharge can occur in the panel capacitor Cp.

During period T3, the first switch SW1 and the fifth switch SW5 are turned off (i.e., opened), and the sixth switch SW6 is turned on (i.e., closed) as per FIG. 6C. With the sixth switch SW6 closed, the inductor L is electrically connected to the first node N1. At this time, the voltage charged in the scan electrode Y of the capacitor Cp is applied to the source capacitor Cs via internal diode D1 of the first switch SW1, the sixth switch SW6 and the inductor L as shown in FIG. 6C. As a result, the source capacitor Cs is charged with voltage Vs/2 during period T3.

During period T4, the fourth switch SW4 is turned off (i.e., opened), and the second switch SW2 and the third switch SW3 are turned on (i.e, closed). With the second switch SW2 is turned on, the first node N1 is electrically connected to the sustain electrode X of the panel capacitor Cp. With the third switch SW3 being turned on, scan electrode Y of the panel capacitor Cp is grounded.

In period T4, as shown in FIG. 6D, the voltage charged in the source capacitor CS during the T3 period is applied to the sustain electrode X of the panel capacitor Cp via the inductor L, the sixth switch SW6 and the second switch SW2. During period T4, the inductor L and the panel capacitor Cp form a LC resonant circuit. Therefore, the voltage of Vs/2 stored in the source capacitor Cs rises to approximately Vs by the LC resonant circuit and is applied to the sustain electrode X of the panel capacitor Cp.

During period T5, the sixth switch SW6 is turned off (i.e., opened), and the fifth switch SW5 is turned on (i.e., closed). With the fifth switch SW5 turned on, the first node N1 is electrically connected to the sustain voltage source Vs. Therefore, as shown in FIG. 6E, the sustain voltage Vs is applied to the sustain electrode X of the panel capacitor Cp from sustain voltage source Vs via the fifth switch SW5 and the second switch SW2 during the T5 period while the scan electrode Y of panel capacitor Cp is grounded. However, since the panel capacitor Cp is already charged with approximately voltage Vs during period T4, energy supplied to the sustain voltage source Vs during period T5 is minimal. The fifth switch SW5 maintains a turn-on state during a period T5 so that a stable sustain discharge can occur in panel capacitor Cp.

During period T6, the second switch SW2 and the fifth switch SW5 to are turned off (i.e., opened), and the sixth switch SW6 is turned on (i.e., closed). With the sixth switch SW6 turned on, the inductor L is electrically connected to the first node N1. During period T6, the voltage charged in the sustain electrode X of the capacitor Cp is applied to the source capacitor Cs via internal diode D2 within second switch SW2, the sixth switch SW6 and the inductor L as shown in FIG. 6F. The source capacitor Cs is charged with the voltage of Vs/2 during period T6.

In the present invention, the sustain pulse is applied alternately between the scan electrodes Y and the sustain electrodes X, while repeating the operation as described above. Meanwhile, when supplying the sustain pulses to the scan electrodes Y and the sustain electrodes X, the present invention shares the fifth switch SW5, the sixth switch SW6, the inductor L and the source capacitor Cs. If the fifth switch SW5, the sixth switch SW6, the inductor L and the source capacitor Cs are shared, the number of components needed can be minimized.

While the present invention has been described in connection with certain exemplary embodiments, it is to be understood that the invention is not limited to the disclosed embodiment, but, on the contrary, is intended to cover various modifications and equivalent arrangements included within the spirit and scope of the appended claims, and equivalents thereof.

What is claimed is:

1. An energy recovery circuit, comprising:
a panel capacitor equivalently arranged within a discharge cell, the panel capacitor including a scan electrode and a sustain electrode;
a source capacitor;
a first switch, a second switch, a third switch, a fourth switch, a fifth switch and a sixth switch;
an inductor;
the inductor and the sixth switch being connected between the source capacitor and the panel capacitor;
the first switch being connected between the sixth switch and the scan electrode of the panel capacitor;
the second switch being connected between the sixth switch and the sustain electrode of the panel capacitor;
the third switch being connected between the scan electrode of the panel capacitor and ground;
the fourth switch being connected between the sustain electrode of the panel capacitor and ground; and
the fifth switch being connected between a first node and a sustain voltage source, the first node being a common node of the first switch, the second switch and the sixth switch.

2. The energy recovery circuit of claim 1, the first switch to maintain a turn-on state when each of a voltage charged in the source capacitor and the sustain voltage source are applied to the scan electrode.

3. The energy recovery circuit of claim 1, the second switch to maintain a turn-on state when each of a voltage charged in the source capacitor and the sustain voltage source are applied to the sustain electrode.

4. The energy recovery circuit of claim 1, the third switch to maintain a turn-on state a while voltage is applied to the sustain electrode of the panel capacitor.

5. The energy recovery circuit of claim 1, the fourth switch to maintain a turn on state while voltage is applied to the scan electrode of the panel capacitor.

6. The energy recovery circuit of claim 1, the sixth switch to maintain a turn on state while each of a voltage being applied from the source capacitor to the panel capacitor and a voltage being recovered from the panel capacitor to the source capacitor.

7. The energy recovery circuit of claim 6, the fifth switch to maintain a turn on state for a period of time after when the voltage is applied from the source capacitor to the panel capacitor.

8. The energy recovery circuit of claim 1, wherein each of the first switch, the second switch, the third switch, the fourth switch, the fifth switch and the sixth switch include an internal diode, the internal diode of the first switch being arranged to allow current to flow from the scan electrode of the panel capacitor to the first node;
the internal diode of the second switch being arranged to allow current to flow from the sustain electrode of the panel capacitor to the first node;
the internal diode of the third switch being arranged to allow current to flow from ground to the scan electrode;
the internal diode of the fourth switch being arranged to allow current to flow from ground to the sustain electrode;
the internal diode of the fifth switch being arranged to allow current to flow from the first node to the sustain voltage source; and
the internal diode of the sixth switch being arranged to allow current to flow from the inductor to the first node.
